(19) United States
(12) Patent Application Publication
(10) Pub. No.: US 2014/0051812 A1
(43) Pub. Date: Feb. 20, 2014

(54) POLYMERIC SURFACE OXIDATION USING PERACIDS

(71) Applicant: Brian Burmaster, Beirut (LB)

(72) Inventor: Brian Burmaster, Beirut (LB)

(21) Appl. No.: 13/896,134

(22) Filed: May 16, 2013

Related U.S. Application Data
(60) Provisional application No. 61/742,617, filed on Aug. 15, 2012.

(51) Int. Cl. C08F 8/06

(52) U.S. Cl. CPC C08F 8/06
USPC 525/344

(57) ABSTRACT

A method for oxidizing polymeric surfaces to render them hydrophilic and more amenable to wetting is disclosed. The method comprises reacting the surface of a hydrophobic polymer with a peracid, especially Caro's acid, under conditions effective to render the surface more hydrophilic. Although strong oxidants can easily carbonize or discolor the surface of organic polymers, polymers can be rendered more hydrophilic without these problems when process conditions are carefully controlled. Specifically, treatment of the polymer surface with a peracid such as Caro's acid requires judicious selection of oxidation temperature, acid concentration, and peroxide content to achieve reaction rates that provide the desired level of hydrophilicity without charring or otherwise damaging the polymer.

### FIELD OF THE INVENTION

The invention relates to a method of oxidizing polymeric surfaces, especially polypropylene, to render them more hydrophilic.

### BACKGROUND OF THE INVENTION

Numerous techniques are used presently to oxidize polymeric surfaces, and most are costly to employ. Generally, oxidation of polymeric surfaces such as polypropylene or polyethylene have involved gas-phase oxidation, such as corona discharge, flame, remote air plasma, ozone or combined UV/ozone treatment. In order to gain an appreciation of the status of this current technology, the reader is directed to work reported by the Surface Science division at the University of Western Ontario (see, e.g., M. Strobel et al., “A Comparison of Gas-Phase Methods of Modifying Polymer Surfaces,” J. Adhesion Sci. Technol. 9 (1995) 365). Additionally, Dr. M. J. Walzak has written articles elucidating the methods in ozone and UV treatments (see, e.g., J. Polym. Sci. A 37 (1999) 2489 and Appl. Surf. Sci. 144-145 (1999) 627). Commercially, 3M uses these gas-phase oxidation processes to treat polymeric surfaces, altering their molecular surface chemical composition, so that adhesion is facilitated.

Inherently, these gas-phase oxidation processes are very energy intensive, requiring large electrical or heat inputs for the entire polymeric material to be processed. Additionally, the equipment needed for this treatment is expensive. In 2010, plasma treatment required an investment cost of about $60 per metric ton and an operating cost of about $100 per metric ton.

Surfactants can be used to reduce surface energy on a hydrophobic polymer, but this is a temporary measure. With time and water exposure, the surfactant will leave the polymeric surface, returning it to the native hydrophobic state.

Another method that has been employed successfully to impart hydrophilicity is the use of a copolymer such as BASF's Irgasurf™ HL 560 additive, which is described in PCT Int. Appl. No. WO 0242530. However, this is an order of magnitude higher in cost than hydrogen peroxide and has the inherent disadvantage of supplying molecular oxygen over the entire bulk polymer and not specifically to the surface.

U.S. Pat. No. 5,004,523 teaches a method for delignification of lignocellulosic materials with aqueous solutions of monoperoxysulfuric acid.

U.S. Pat. No. 5,246,543 teaches a method for delignification and bleaching of a lignocellulosic material.

U.S. Pat. No. 5,621,118 teaches a process for oxidizing a substrate susceptible to nucleophilic oxidation.

U.S. Pat. No. 6,090,297 teaches a process for treating precious metal tailing slurries with Caro's acid.

U.S. Pat. No. 6,878,289 teaches a method of cleaning water systems and a potassium monopersulfate composition used for the method.

Eur. Pat. Appl. No. 1339899 teaches a way to make wettable polyolefin fibers and fabrics.

Caro's acid, or peroxymonosulfuric acid (H₂SO₅), has been previously employed in some industries, most notably in cyanide destruction and pulp bleaching. However, Caro's acid is unknown as an oxidizing agent for polymeric surface treatment.

Permanent chemical oxidation or modification of polymeric surfaces currently requires expensive processes, such as the gas-phase modifications to molecular structure (plasma treatment, ozone and UV irradiation, corona discharge, flame ionization) discussed above. All of these methods are expensive. The industry would benefit from an economical way to alter the hydrophilicity of a hydrophobic polymer surface.

### SUMMARY OF THE INVENTION

The invention relates to a method for oxidizing polymeric surfaces to render them hydrophilic and more amenable to wetting. In particular, the method comprises reacting the surface of a hydrophobic polymer with a peracid under conditions effective to render the surface more hydrophilic. Although strong oxidants can easily carbonize or discolor the surface of organic polymers, I found that polymers can be rendered more hydrophilic without these problems when process conditions are carefully controlled. Specifically, treatment of the polymer surface with a peracid such as Caro's acid requires judicious selection of oxidation temperature, acid concentration, and peroxide content to achieve reaction rates that provide the desired level of hydrophilicity without charring or otherwise damaging the polymer.

### BRIEF DESCRIPTION OF THE DRAWINGS

FIG. 1 is a schematic to show how contact angle of a liquid drop is measured.

FIG. 2 shows how the contact angle of a water droplet on different surfaces varies.

FIG. 3 shows photographs of water droplets on polypropylene.

FIG. 4 is a photograph showing drainage of liquid from a filter.

FIG. 5 plots drainage rate versus time for a wetted filter with and without surfactant.

FIG. 6 is a plot of oxidation-reduction potential (ORP) readings for polypropylene samples treated with Caro's acid.

FIG. 7 is a schematic showing a separatory funnel, filter holder, and graduated cylinder assembly used to measure effluent.

FIG. 8 is a plot of Hammett acidity at 25° C. as a function of sulfuric acid concentration.

FIG. 9 shows photographs of discolored polypropylene and polyethylene samples following treatment with Caro's acid and insufficient hydrogen peroxide.

FIG. 10 shows photographs of samples of polypropylene either untreated or treated with Caro's acid in accordance with the invention.

FIG. 11 shows photographs of samples of polytetrafluoroethylene either untreated or treated with Caro's acid in accordance with the invention.

FIG. 12 is a plot of oxidation-reduction potential readings in 20% fuming sulfuric acid with subsequent addition of 50% hydrogen peroxide.

FIG. 13 is a plot of oxidation-reduction potential readings in 86% phosphoric acid with subsequent addition of 50% hydrogen peroxide.

### DETAILED DESCRIPTION OF THE INVENTION

The inventive method comprises reacting the surface of a hydrophobic polymer with a peracid under conditions effective to render the surface more hydrophilic. Although strong oxidants can easily carbonize or discolor the surface of organic polymers, I found that polymers can be rendered more hydrophilic without these problems when process conditions are carefully controlled. Specifically, treatment of the polymer surface with a peracid such as Caro's acid requires judicious selection of oxidation temperature, acid concentration, and peroxide content to achieve reaction rates that provide the desired level of hydrophilicity without charring or otherwise damaging the polymer.

Suitable hydrophobic polymers are well known. As used herein, “hydrophobic polymer” means a polymer that resists wetting by water. Typical hydrophobic polymers have a water contact angle greater than 90 degrees. Examples include polyolefins (polypropylene, polyethylene, polyisoprene, ethylene-propylene copolymers), ethylene-vinyl acetate copolymers, polytetrafluoroethylene, styrene polymers, styrene-acrylonitrile copolymers with low acrylonitrile content, halogenated hydrocarbon polymers, vinyl polymers, acrylic and methacrylic polymers, thermoplastic polyesters, and the like. Polyolefins, especially branched polyolefins, are preferred. Polypropylene is particularly preferred. For additional examples of suitable hydrophobic polymers, see U.S. Pat. No. 5,998,023, the teachings of which are incorporated herein by reference.

Caro's acid is a mixture of concentrated hydrogen peroxide (H₂O₂) and either sulfuric acid (H₂SO₄) or oleum (H₂S₂O₇). The resultant mixture is more oxidizing than either one of these constituents. The overall reaction can be written as:

H₂SO₄+H₂O₂⇄H₂SO₅+H₂O

As illustrated in Table 1, Caro's acid is one of the most powerful oxidants as measured by the oxidation-reduction potential (ORP):

TABLE 1
Oxidation-Reduction Potential

| Chemical | Temperature | ORP range | |
|---|---|---|---|
| water | 10° C. to 30° C. | 300 to 400 | mv |
| 30 wt. % H2O2 | 0° C. to 30° C. | 450 to 550 | mv |
| 20 wt. % oleum | 0° C. to 10° C. | 800 to 900 | mv |
| Caro's acid | 50° C. to 150° C. | 1200+ | mv |

Liquid-phase oxidation using a peracid such as Caro's acid will be significantly less expensive than traditional gas-phase oxidation methods because molecular oxygen is supplied in the form of hydrogen peroxide directly to the polymeric surface. The resultant operating and capital treatment costs should be an order of magnitude lower with the inventive peracid method.

In a preferred aspect, the peracid used is Caro's acid (peroxymonosulfuric acid), which is normally prepared by combining hydrogen peroxide and sulfuric acid or oleum (fuming sulfuric acid). The Caro's acid preferably comprises sulfuric acid in a concentration within the range of 70 to 90 wt. %, more preferably 75 to 85 wt. %, and most preferably 78 to 82 wt. %. When the concentration of H₂SO₄ is too high, there is insufficient peroxide content, and the polymer surface can char instead of giving the desired oxidation, as is demonstrated below. The Caro's acid preferably comprises 2 to 15 wt. %, more preferably 5 to 10 wt. %, and most preferably 6 to 9 wt. % of charged hydrogen peroxide. Preferably, the Caro's acid comprises at least 5 wt. % water, more preferably at least 10 wt. % water. A more preferred range for the water content of the Caro's acid is 5 to 25 wt. %. This allows a controlled rate of oxidation at the surface of the hydrophobic polymer.

Although Caro's acid is most preferred, peroxyphosphoric acid (H₃PO₅), can also be used.

Preferably, the reaction is performed at a temperature within the range of 20° C. to 200° C., more preferably from 80° C. to 160° C.

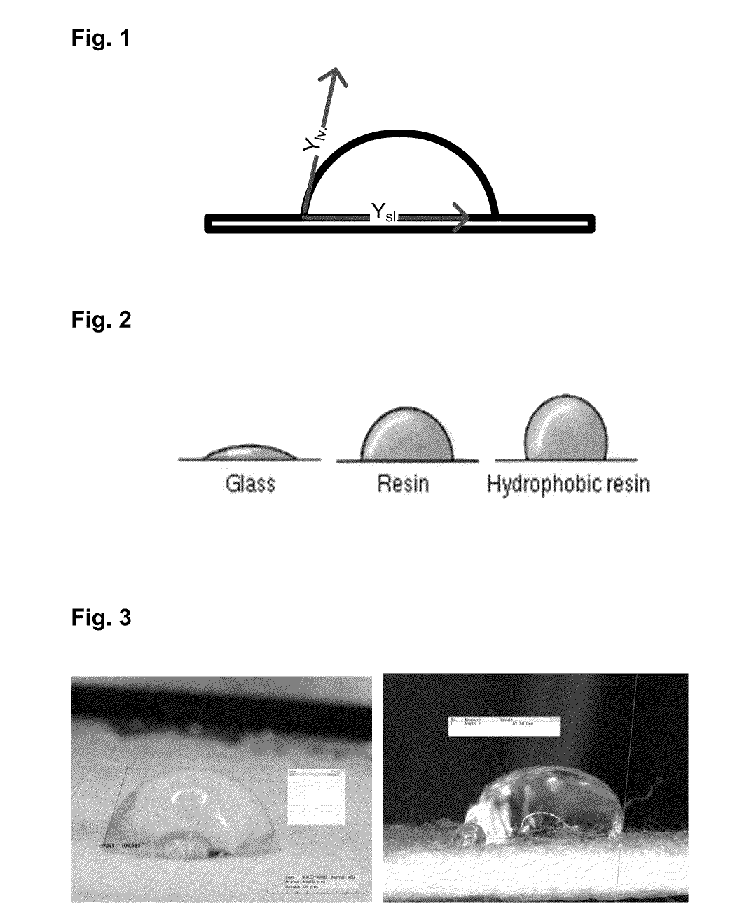

The desired result from all of these treatments is to render the surface more hydrophilic from its native hydrophobic state. An index of this measurement is the contact angle, which is shown in FIG. 1. The contact angle is the result of the interfacial energy between the liquid droplet and the polymeric surface, thus forming the familiar bubble shape. Water droplets on different surfaces will have varying contact angles, as shown in FIG. 2. For glass, the contact angle is 20 to 30 degrees; for resin, the contact angle is 80 to 90 degrees; and for a hydrophobic resin, the contact angle is greater than 90 degrees.

Generally, polymeric surfaces such as polypropylene are naturally hydrophobic, meaning that these contact angles with water or other high surface tension liquids are in excess of 90 degrees. Conversely, liquids that have reduced surface tensions such as organic solvents will exhibit lower contact angles.

FIG. 3 shows two photographs that illustrate the behavior of water droplets on polypropylene filter material.

As the polymeric surface is modified to incorporate more oxygen, the contact angle will decrease, the polymer will be more hydrophilic, and liquid will flow at much higher rates. As described in the scientific literature, other indices of hydrophilicity and hydrophobicity are the water retention ratio and the drainage rate.

The water retention ratio (R_{water}) is given by the equation:

$${R}_{water} = \frac{Weight of fully wetted surface}{Weight of fully dried surface}$$

With increasing hydrophilicity, the water retention ratio will increase since contact angles are reduced and the polymeric surface can retain more water.

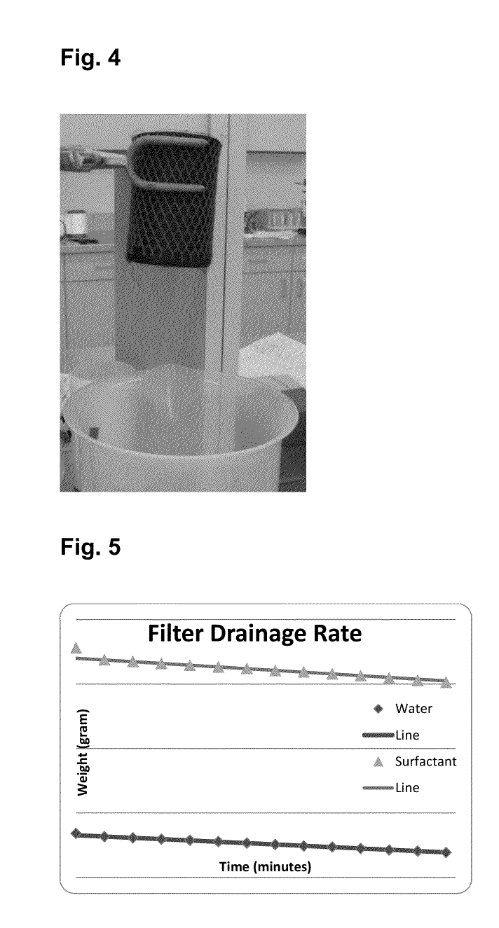

Similarly, with lower interfacial energy between the polymer and the liquid, drainage flow rates are much higher. As a working example, the same filter constructed of small polypropylene fibers was fully wetted by submerging it in water over a three to four day period and then suspending that filter in air, as shown in FIG. 4. This filter is then weighed every 30 minutes. Originally, the filter contained a surfactant which was used by the fiber manufacturer as a wetting and anti-static agent. With continual washing and drying, the surfactant washes away.

These drying or drainage rate results of the fully wetted filter with a surfactant (top line) and without a surfactant (bottom line) are shown in FIG. 5. The fully dried filter had a weight of 157 grams. Both indices show that with removal of the surfactant the surface becomes more hydrophobic, which is indicative of lower readings, as shown below in Table 2:

TABLE 2
Hydrophilicity vs. Hydrophobicity Index

| Index | Surfactant | Water |
|---|---|---|
| Retention ratio | 2.09 | 1.17 |
| Drainage rate (g/h) | 2.71 | 2.06 |

As stated previously, the surfactant will make the top layer of the polypropylene structure more hydrophilic, but only as a temporary measure.

Surfactants lower the interfacial surface energy thus hydrophilic indices improve such as drainage rates, retention ratio and lower contact angles. As a further illustration that these drainage rates are related to surface phenomena, drainage rate experiments were conducted with 5 micron felt, 0.070-inch thick polypropylene filters supplied by McMaster-Carr (catalog#9242T11), and the results are shown in Table 3:

TABLE 3
Drainage Rate of Various Liquids

| Chemical | Surface Tension (dynes/cm) | Drainage rate (g/h) |
|---|---|---|
| H₂SO₄, 15 wt. % | 74.3 | 0.36 |
| H₂SO₄, 8.8 wt. % | 73.5 | 0.39 |
| water | 72.0 | 0.42 |
| acetonitrile | 25.5 | 3.58 |
| benzene | 25.0 | 5.63 |
| ethanol, 75 wt. % | 24.4 | 1.33 |
| isopropanol | 23.3 | 2.51 |
| methanol | 22.1 | 3.32 |
| n-pentane | 15.5 | 10.4 |

These results demonstrate that low surface tension liquids will yield faster drainage rates than higher surface tension liquids.

Caro's acid is widely used in the gold mining industry to oxidize toxic cyanide compounds. This peroxygen acid is extremely oxidizing. Polypropylene felt 5 micron filters from McMaster-Carr were modified using Caro's acid at the concentrations shown in Table 4:

TABLE 4
Caro's Acid Treatment of Polypropylene Fibers

| Process condition | Sample #1 | Sample #2 | Sample #3 |
|---|---|---|---|
| filter weight, g | 0.53 | 0.49 | 0.61 |
| H₂SO₄, wt. % | 87.3 | 70.7 | 89.5 |
| H₂O₂, wt. % | 1.9 | 7.3 | 2.0 |
| water, wt. % | 10.8 | 22.1 | 8.5 |

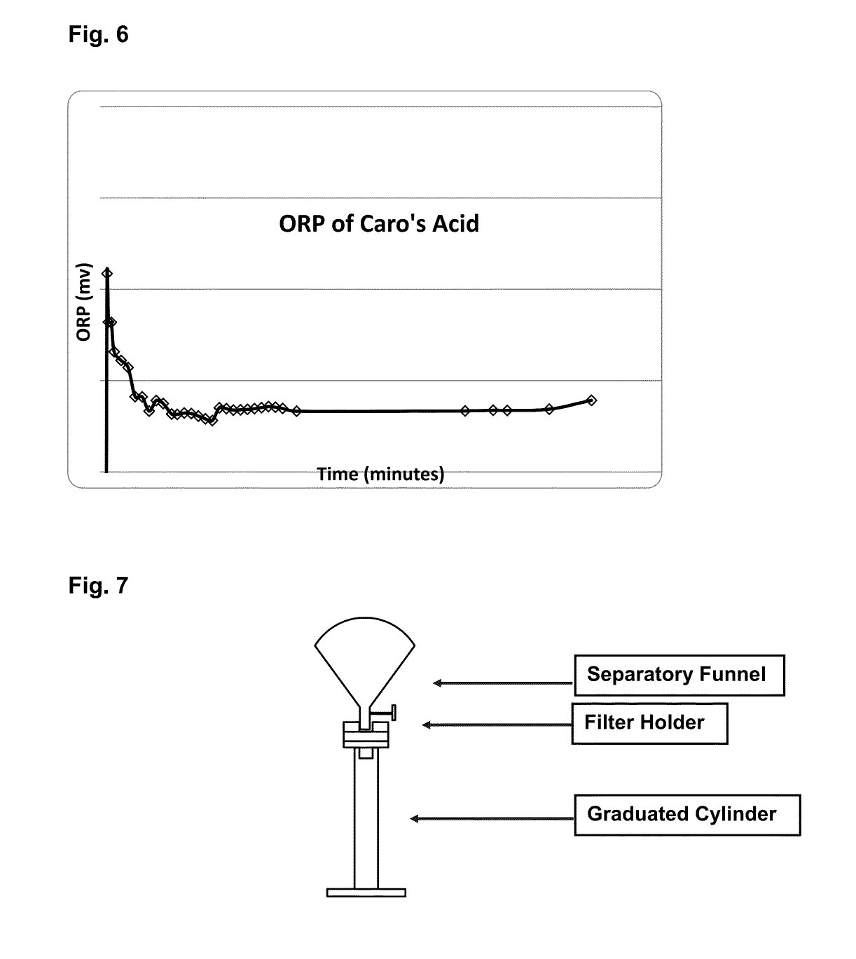

The temperature of the first two “Caro-ized” samples was approximately 65° C., while the third sample reached a maximum temperature of 73° C. Oxidation-reduction potential (ORP) readings of Sample #3 are shown in FIG. 6. As shown in the figure, upon introduction of the polypropylene felt material, the oxidation-reduction potential declined dramatically, using all of the available oxidant from the solution before reaching a steady-state value within one to two hours. It is clear that Caro's acid is chemically oxidizing the polypropylene surface permanently to form carboxylic acid (COOH) or sulfonic acid (SO₃H) groups. To test the hypothesis that acidic groups are on the surface, the following experiment was implemented.

Upon thoroughly rinsing the polypropylene filters with deionized water, the filters were placed in a holder, as shown in FIG. 7. A mild solution of sodium hydroxide was placed in the separatory funnel and the liquid was allowed to slowly drip over the filter. The filtrate was collected in the graduated cylinder. If the treated surface does contain acidic groups, then there should be a measurable decrease in the pH and normality of the solution across the filter assembly. With untreated polypropylene filters, there was no noticeable difference between the input and output pH and normality of the caustic solution, as expected.

This experiment was repeated with the treated polypropylene filter material that had been exposed to Caro's acid, and the results are shown in Table 5:

TABLE 5
pH and Normality Measurement on Caro's Filter #3

| Sample #3 | Inlet | Outlet |
|---|---|---|
| pH | 12.25 | 12.16 |
| Normality (eq./L) | 0.0093 | 0.0085 |

Additional experiments were conducted to determine whether there were sulfonic acid groups present. A weak copper chloride solution was used this time in an identical procedure instead of mild caustic. The results appear in Table 6:

TABLE 6
Copper Recovery in Caro's Filter

| Sample | Spectrophotometer | pH | Conductivity |
|---|---|---|---|
| Untreated #1 | −5.2% | +30% | +1.3% |
| Untreated #2 | −5.3% | −15% | −0.1% |
| Treated #1 | +8.2% | +30% | +1.0% |
| Treated #2 | +32.0% | +54% | +4.2% |

The Hach spectrophotometer method was the most accurate analytical technique and was specific for copper ions. From this experiment, it is reasonable to conclude that copper was absorbed by the polypropylene that was treated previously by Caro's acid. Because weakly acidic carboxylic acid groups will not absorb copper, sulfonic acid groups must be present on the chemically modified surface.

As further evidence, these filters were submitted to the University of British Columbia for X-ray photon spectroscopy (XPS), and the results of that surface analysis show that sulfur is present (see Table 7):

TABLE 7
XPS Elemental Analysis of Polypropylene Filters

| | Sample #1 | Sample #2 | Sample #3 |
|---|---|---|---|
| Elemental analysis | untreated | untreated | treated |
| carbon, % | 90.7 | 96.0 | 80.8 |
| oxygen, % | 8.9 | 3.1 | 13.0 |
| sulfur, % | 0.0 | 0.0 | 1.8 |
| other, % | 0.3 | 0.9 | 4.4 |

This surface elemental analysis confirms that sulfur is present on the treated polypropylene filter but not the untreated samples. Additionally, this treated sample contains a higher percentage of elemental oxygen and a lower percentage of elemental carbon, which is consistent with surface oxidation.

From Colin Rochester's treatise entitled Acidity Functions (Academic Press; London and New York, 1970) on reaction rates of many acids with organic compounds, the pH scale cannot be employed, since in these strong acids it cannot be measured. Instead, acidity is measured with indices such as the Hammett acidity function (Hₒ), which measures the reaction rate of various acids, including sulfuric acid, nitric acid, perchloric acid and many other acids with a variety of different organic compounds, such as toluene, phenols, pentanol, polyvinyl alcohol, and others in a variety of different reactions, including nitration and sulfonation.

In general, the reaction of Caro's acid or any other peracid with polypropylene or other hydrocarbon polymers should follow the Hammett acidity function curve. For sulfuric acid, the Hammett acidity function is given in FIG. 8. The implication of this relationship is straightforward: to increase the reaction rate, stronger concentrations of both sulfuric acid and hydrogen peroxide are needed. Conversely, lower water contents are desired.

Fuming sulfuric acid or oleum (20 wt. % SO₃) was obtained and added with 30 wt. % hydrogen peroxide. The resulting Caro's acid was highly concentrated and very reactive. At the same time, it was recognized that higher purity polypropylene was needed for analytical XPS purposes. Sintered polypropylene and polyethylene samples were obtained from Porex (Georgia, USA) and Porvair (UK) and reacted with highly concentrated Caro's acid.

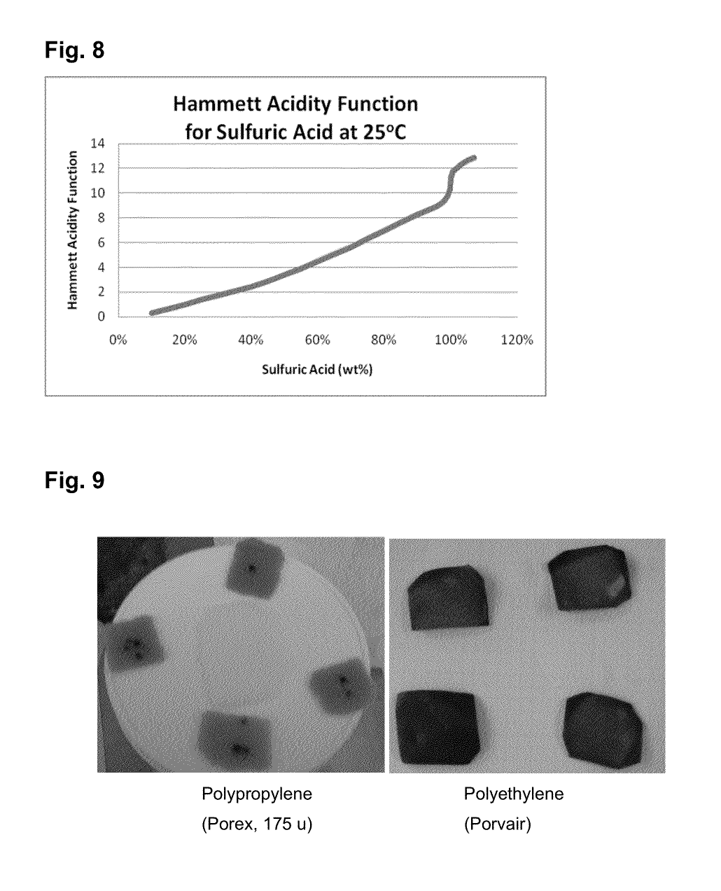

The initial samples displayed significant discoloration or charring. The polyethylene samples were chemically burned within seconds, and the resulting photographs of these samples are shown in FIG. 9. It was hypothesized that the charring was a result of the oxidation state of carbon, as shown in Table 8.

TABLE 8
Oxidation State of Carbon

| | | | |
|---|---|---|---|
| oxidation state | −4 | 0 | +4 |
| substance | plastic | elemental | carboxylic acid |
| | | carbon | |
| color | white | black | white |

Thus, this discoloration is a qualitative measure of the oxidation-reduction potential measurement, with insufficient molecular oxygen in the form of hydrogen peroxide available to fully oxidize the polymeric surface. Thus, the ratio of peroxide to sulfuric acid must be increased in order to avoid this “charring” or elemental carbon formation within the plastic's top layer.

However, for fast reaction rates, per the Hammett acidity graph of FIG. 8, free water concentration must be reduced to low levels.

With fuming oleum (20 wt % SO₃), free water concentration can be reduced drastically, and according to the acidity function teachings, reaction rates are extremely fast. Four Porex polypropylene samples were “Caro-ized” according to the process conditions shown in Table 9:

TABLE 9
Process Conditions of Porex Samples

| | |
|---|---|
| H₂SO₄, wt. % | 97.0 |
| H₂O₂, wt. % | 2.2 |
| water, wt. % | 0.8 |
| temperature, ° C. | 77 to 108 |

Four polypropylene filter samples were taken from the Caro's acid vessel at various times and then rinsed and dried. Hydrophilicity and hydrophobicity data were taken in the form of water retention ratio and drainage rates to ascertain the reaction rate of the polypropylene surface and Caro's acid. That data appears in Table 10:

TABLE 10
Hydrophilicity and Hydrophobicity Indices

| Reaction time, min. | Retention ratio | Drainage rate (%/h) |
|---|---|---|
| 0 (untreated) | 1.50 | 12.0 |
| 8 | 1.71 | 21.9 |
| 40 | 1.85 | 22.5 |
| 70 | 1.70 | 21.9 |
| 120 | 1.78 | 21.1 |

From Table 10, the reaction of polypropylene with Caro's acid appears to take only a few minutes. The 8-minute sample attained the very high drainage rates and the superior water retention ratio of treated polypropylene samples. However, from the discoloration evidenced in the photographs of FIG. 9, concentrations of oleum and hydrogen peroxide had not been optimized.

To test the hypothesis that discoloration was the result of an insufficient amount of hydrogen peroxide being present, the ratio of peroxide to oleum (20% free SO₃) was increased, and the resulting Caro's acid was reacted with Porvair's 5 micron polypropylene PPD filters. Process conditions are shown in Table 11:

TABLE 11
Process Conditions of Porvair Samples

| | |
|---|---|
| H₂SO₄, wt. % | 75.8 |
| H₂O₂, wt. % | 8.2 |
| water, wt. % | 16.0 |
| temperature, ° C. | 85 to 155 |

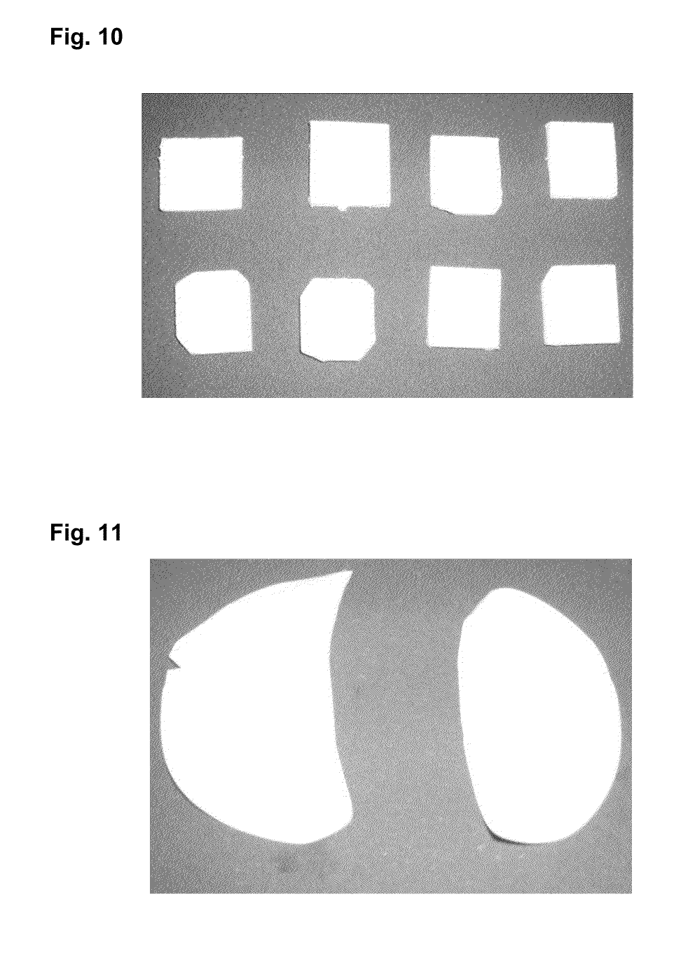

When the available peroxygen concentration was increased significantly, the discoloration that was evidenced in the previous samples was nearly eliminated. Four “Caro-ized” polypropylene samples that underwent this treatment are shown along with four untreated samples in FIG. 10. The treated samples (#3, 5, 6, and 8 when read from left to right, top to bottom), which have notched corners, are virtually indistinguishable from the untreated ones (#1, 2, 4, and 7), suggesting that discoloration is a function of the available hydrogen peroxide content.

Reaction rates are slower because the free water content is much higher than the previous condition. These Porvair polypropylene samples were analyzed by XPS at the University of Western Ontario's Surface Science Centre, and the results appear in Table 12:

TABLE 12
XPS Elemental Analysis of Polypropylene Filters

| Elemental | Sample #1 | Sample #2 | Sample #3 |
|---|---|---|---|
| analysis | untreated | Caro's acid, 4 min. | Caro's acid, 60 min. |
| carbon, % | 93.4 | 90.3 | 70.7 |
| oxygen, % | 4.7 | 6.5 | 21.1 |
| sulfur, % | 0.0 | 0.4 | 0.4 |
| other, % | 1.9 | 2.8 | 7.8 |

Sulfur was only present on the treated samples, indicating that there were sulfonic acid groups present on the surface, as found previously. Oxidation proceeded at a slower reaction rate, since water content was relatively high, especially when compared to the previous polypropylene samples.

To determine hydrophilicity, these polypropylene samples were measured for contact angles in the laboratory at the University of Western Ontario. Those results appear in Table 13:

TABLE 13
Contact Angle of Polypropylene Filters

| | Sample #1 | Sample #2 | Sample #3 |
|---|---|---|---|
| Contact angle | untreated | Caro's acid, 4 min. | Caro's acid, 60 min. |
| Advancing angle | 121.3° | 108.5° | 99.5° |
| Static angle | 128.0° | 114.7° | 109.5° |

From these measurements, it is apparent that these polypropylene samples were rendered more hydrophilic with Caro's acid treatment, which oxidizes the surface, imparting both sulfonic acid and carboxylic acid groups.

In a preferred aspect, the hydrophobic polymer is polypropylene, and the reacted surface when wetted with water has a static contact angle less than 120 degrees. A more preferred static contact angle is within the range of 110 degrees to 116 degrees.

I also found that Caro's acid treatment of hydrophobic polymers imparts desirable hydrophilicity without compromising important physical and mechanical properties. Samples of Caro's acid-treated and untreated polypropylenes were found to have similar fiber physical properties, unlike adding a copolymer (such as Irgasurf™ HR 560 additive) to impart hydrophilicity, as shown below in Table 14 below:

TABLE 14
Polypropylene Fiber Physical Properties

| | | Irgasurf ™ HR | | | |
|---|---|---|---|---|---|
| | | 560 additive* | | | |
| | Caro's | 0% | | | |
| | acid | (control) | 1% | 3% | 5% |
| Denier, g/9000 m | 137.4 | 137.5 | 137.0 | 136.0 | 128.5 |
| Elongation, mm | 58.4 | 58.0 | 66.0 | 65.6 | 79.0 |
| Maximum load, N | 6.03 | 6.05 | 5.92 | 5.75 | 5.71 |

*Product of BASF

Table 15 summarizes the results from treatment of various polypropylene samples. As shown in the table, the hydrophilicity of a polypropylene surface can be enhanced with Caro's acid having as little as about 2 wt. % of hydrogen peroxide content, typically 2 to 10 wt. %, and charring can be avoided by keeping the sulfuric acid content below 90 wt. %, typically 70 to 90 wt. %. Treatment time and temperature appear to be less important than the composition of the Caro's acid used.

To test the hypothesis that other polymeric material could be rendered more hydrophilic using the Caro's acid treatment, polytetrafluoroethylene (PTFE) membranes from Sterlitech Corporation (Part number PTU-59010), which are unlaminated 5.0 micron sheets, were placed in a concentrated Caro's acid solution (93.5 wt % H₂SO₄, 3.2% H₂O₂ and 3.3% H₂O) overnight for 20 hours at room temperature (22° C.), and the retention ratio increased significantly from 1.02 to 1.55. FIG. 11 shows the untreated PTFE filter (on the right, no notch) and the Caro's acid-treated PTFE filter (on the left, notched). As shown in the photo, there is no apparent difference in the treated and untreated samples.

TABLE 15
Summary Results with Treatment of Polypropylene Samples with Caro's Acid

| | | | | | | Drain | Retention | |
|---|---|---|---|---|---|---|---|---|
| PP | % | % | % | Temp, | Time, | rate | ratio | |
| source | H₂SO₄ | H₂O₂ | H₂O | ° C. | min | increase, % | increase, % | Char? |
| M-C | 70.7 | 7.3 | 22.1 | 65 | 38 | 13 | 60 | No |
| M-C | 84.1 | 2.9 | 12.9 | 63 | 180 | 7.2 | 49 | No |
| M-C | 87.3 | 1.9 | 10.8 | 65 | 40 | 12 | 55 | No |
| M-C | 87.9 | 1.7 | 10.4 | 73 | 72 | 9.8 | 51 | No |
| Porvair | 75.8 | 8.2 | 16.0 | 155 | 4, 7, | — | — | No |
| PP | | | | | 26, 40 | | | |
| Porvair | 73.4 | 8.9 | 17.7 | 110 | 4, 11, | — | — | No |
| PPD | | | | | 35, 64 | | | |
| Porex | 97.0* | 2.1 | 0.85 | 119 | 8 | — | — | Yes |
| | 97.0* | 2.1 | 0.85 | 119 | 40 | — | — | Yes |
| | 97.0* | 2.1 | 0.85 | 119 | 70 | — | — | Yes |
| | 97.0* | 2.1 | 0.85 | 119 | 120 | — | — | Yes |

*Comparative examples
M-C: McMaster-Carr polypropylene

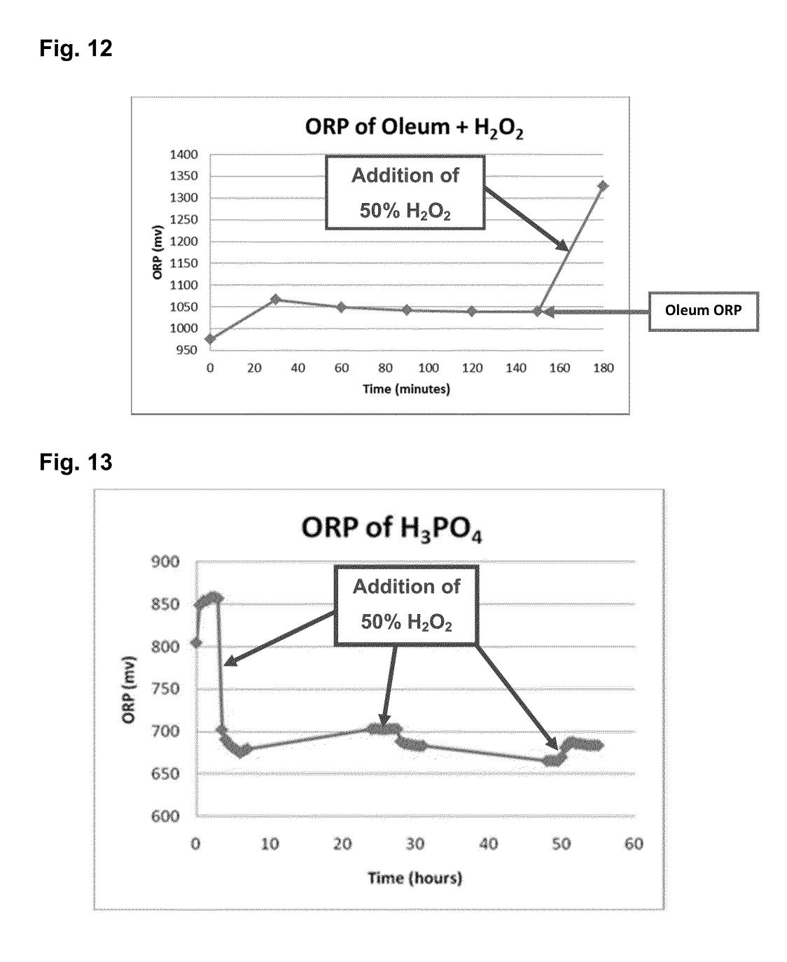

In all of the preceding examples, Caro's acid (sulfuric acid and hydrogen peroxide) was used to treat the polymeric surfaces. FIG. 12 shows the resulting oxidation-reduction potentials (ORP) of 20% fuming sulfuric acid with the subsequent addition of 50% hydrogen peroxide showing increased ORP readings. This figure shows that high levels of oxidation can be achieved with Caro's acid.

To assess the suitability of other peracid candidates to replace Caro's acid for polymeric oxidation, other inorganic acids were tested with subsequent addition of 50% hydrogen peroxide. ORP readings were monitored and phase changes were noted. Table 16 shows the results with other inorganic acids:

TABLE 16
Inorganic Peracids

| Inorganic Acid | Formula | ORP Readings | Result of H₂O₂ Addition |
|---|---|---|---|
| Sulfuric | H₂SO₄ | 950 to 1350 mv | No reaction - ORP increase |
| Nitric | HNO₃ | 1200 to 850 mv | NO₂ release - ORP decrease |
| Hydrochloric | HCl | 1050 to 950 mv | Cl₂ release - ORP decrease |
| Phosphoric | H₃PO₄ | 850 to 680 mv | No reaction - ORP decrease |

Phosphoric acid may be the best replacement as a non-volatile peracid to sulfuric acid because it possesses similar physical properties (see Table 17):

TABLE 17
Physical Property Comparison

| Physical Property | H₂SO₄ | H₃PO₄ |
|---|---|---|
| Density, g/cm³ | 1.84 | 1.69 |
| Boiling point, ° C. | 367 | 158 |
| Melting point, ° C. | 10 | 21 |
| Vapor pressure, mmHg | 0.002 | 0.03 |
| Hammett acidity | 11.94 | 5.25 |

Oxidation-reduction potential measurements of phosphoric acid (JT Baker catalog 0260-050, 86.2 wt. %) were taken with the addition of 50 wt. % hydrogen peroxide. In general, phosphoric acid is an oxidizing acid, but with the supplemental H₂O₂ there was a noticeable drop in the oxidation-reduction potential, as shown below in FIG. 13.

The preceding examples are meant only as illustrations; the following claims define the scope of the invention.

I claim:

1. A method which comprises reacting the surface of a hydrophobic polymer with a peracid under conditions effective to render the surface more hydrophilic.

2. The method of claim 1 wherein the peracid is selected from the group consisting of Caro's acid and peroxyphosphoric acid.

3. The method of claim 1 wherein the peracid is Caro's acid.

4. The method of claim 3 wherein the Caro's acid comprises at least 2 wt. % of hydrogen peroxide and less than 90 wt. % of sulfuric acid.

5. The method of claim 3 wherein the Caro's acid comprises at least 3 wt. % of hydrogen peroxide and less than 85 wt. % of sulfuric acid.

6. The method of claim 3 wherein the sulfuric acid is present in an amount within the range of 70 to 90 wt. %.

7. The method of claim 3 wherein the hydrogen peroxide is present in an amount within the range of 2 to 15 wt. %.

8. The method of claim 3 wherein the Caro's acid comprises at least 5 wt. % of water.

9. The method of claim 3 wherein the Caro's acid comprises at least 10 wt. % of water.

10. The method of claim 1 wherein the reacted surface has carboxylic acid groups, sulfonic acid groups, or both.

11. The method of claim 1 wherein the hydrophobic polymer is polypropylene.

12. The method of claim 11 wherein the reacted surface when wetted with water has static contact angle less than 120 degrees.

13. The method of claim 11 wherein the reacted surface when wetted with water has static contact angle within the range of 110 to 116 degrees.

14. The method of claim 1 wherein the hydrophobic polymer is polytetrafluoroethylene.

15. The method of claim 1 wherein the hydrophobic polymer is polyethylene.

16. The method of claim 1 wherein the reaction is performed at a temperature within the range of 80° C. to 160° C.
